(19) United States
(12) Patent Application Publication
(10) Pub. No.: US 2007/0164120 A1
(43) Pub. Date: Jul. 19, 2007

(54) Forming method of Micro SD card

(76) Inventor: En-Min Jow, Hsinchu (TW)

Correspondence Address: BIRCH STEWART KOLASCH & BIRCH, PO BOX 747, FALLS CHURCH, VA, 22040-0747, US

(21) Appl. No.: 11/334,413

(22) Filed: Jan. 19, 2006

(51) Int. Cl. G06K 19/06

(52) U.S. Cl. 235/492

(57) ABSTRACT

A forming method of Micro SD card (Micro Secure Digital Memory card) is provided. The plurality of Micro SD card module substrates is located on the substrate and connecting every adjacent module substrates with the plurality of connecting bars. After placing the chip to the proper location and molding the whole module. In order to polish the Micro SD card from rough surface to smooth and clear the plurality of bumps that caused by the punch step, utilizing the plurality of steps, such as punch, grind and chamfer to achieve the goal to smooth the Micro SD surface and reduce the cost.

### BACKGROUND OF THE INVENTION

1. FIELD OF THE INVENTION

The present invention relates to a forming method of data storage device, and more especially, relates to a forming method of Micro SD card.

2. DESCRIPTION OF THE PRIOR ART

The Micro SD card (Micro Secure Digital memory card) is a light and handy, portable data storage device, it may uses on different electronic apparatus, such as, personal computer, cell phone, digital camera . . . etc. As shown in FIG. 1A and FIG. 1B, illustrating the front view and the back view of Micro SD card respectively. The shape of Micro SD card 1 is multilateral and has a salient shape and a re-entrant shape 2 on one side. The prior cutting process of Micro SD card is to cut and separate the plurality of Micro SD card assemblies to a plurality of unitary assemblies. Please refer to FIG. 2, is the front view diagram and illustrates the generally forming method of the unitary Micro SD card. To arrange the plurality of Micro SD card module substrates 12 on a substrate 10, after placing the chip (not shown) on the proper location, then cover the whole surface of the substrate 10, which includes the plurality of unitary Micro SD card module substrates 12 by the molding compound 20. Wait until the molding compound 20 harden, exploiting the water jet or the laser-cutting machine (not shown) to separate a plurality of Micro SD card assemblies to the plurality of unitary Micro SD card 1 accurately. However, the laser-cutting machine and the water jet machine are very expensive equipments, the water jet machine even needs extra abrasives to achieve cutting purpose. Besides, no matter using laser or water jet method to process cutting, it must spend more time to calibrating the machine precisely and the cutting process is so slow. The productivity is lower relatively. In order to achieve the goal that Micro SD card has no rough surface after cutting, the expensive cutting equipment, the low productivity, and the exorbitant cost are the portion of blemish in an otherwise perfect thing. Therefore, these are urgent issues that enterprises need to overcome currently.

### SUMMARY OF THE INVENTION

According to the issue mentioned previously, the present invention provides a forming method of Micro SD card.

It is an object of this invention to provide a forming method of Micro SD card, to arrange the plurality of Micro SD card module substrates and the plurality of connecting bars on a substrate. When processing the molding steps, just needs injecting the molding compound into the Micro SD card module substrate instead of injecting the molding compound into the whole substrate. As this result, this invention avoids the waste of the molding compound and reduces the cost of the molding compound.

Another object of this invention is to provide a forming method of Micro SD card, exploiting the punch method to separate the plurality of connecting bars, which are on the substrate. The punch method can separate the substrate and the Micro SD card assembly directly, without using the expensive cutting equipment (such as laser cutting machine or water jet) to process the cutting. This invention can reduce the cost of the production equipment and also raises the productivity.

Another object of this invention is to provide a forming method of Micro SD card, exploiting the punch device to go though the assembly cutting process. Regarding the cutting speed of the punch device is faster than the traditional laser-cutting machine or water-jet machine. This invention can raise the productivity due to the short cutting processing time.

Another object of this invention is to provide a forming method of Micro SD card. The plurality of connecting bars are designed on the substrate to avoid the molding compound peeling or the assembly cracks due to the punch location is too close to the assembly when punching. It can raise the production yield furthermore.

Another object of this invention is to provide a forming method of Micro SD card. Accurately polish and chamfer the extra, unnecessary molding compound, which caused by the punch process, to achieve the goal that Micro SD card has no rough surface after punching.

Accordingly, one embodiment of the present invention provides a forming method of Micro SD card. It contains to arrange the plurality of Micro SD card module substrates on the substrate and connecting every adjacent module substrates with the plurality of connecting bars. After placing the chip on the proper location and molding the whole module, each assembly connecting with adjacent assemblies and the substrate by the plurality of connecting bars. And then use the punch device to dismember the plurality of connecting bars, as this result, the plurality of Micro SD card assemblies, the substrate, and the adjacent Micro SD card assemblies can be separated. Next, to exploit saw-tooth tools to process the detail and smoothing, such as grind, polish and chamfer to achieve the goal that Micro SD card has no rough surface after punch and fits the international standard size.

These and other objects will appear more fully from the specification below.

### BRIEF DESCRIPTION OF THE DRAWINGS

FIG. 1A and FIG. 1B illustrate the front view and the back view of Micro SD card respectively;

FIG. 2 illustrates the generally forming method of the unitary Micro SD card;

FIG. 3A illustrates the substrate design in accordance with an embodiment of the present invention;

FIG. 3B illustrates the molding area of Micro SD card assembly before punch in accordance with an embodiment of the present invention;

FIG. 3C illustrates the Micro SD card assembly, which after punch in accordance with an embodiment of the present invention;

FIG. 3D illustrates the side view of the Micro SD card assembly, which after punch in accordance with an embodiment of the present invention;

FIG. 4A, FIG. 4B, FIG. 4C and FIG. 4D illustrate the smoothing steps in accordance with an embodiment of the present invention;

FIG. 5 is a flow chart illustrating the Micro SD card forming method in accordance with an embodiment of the present invention; and

FIG. 6 illustrates the shape of the connecting bars, the distribution of the connecting bars, and the mount of the connecting bars in accordance with different embodiments of the present invention.

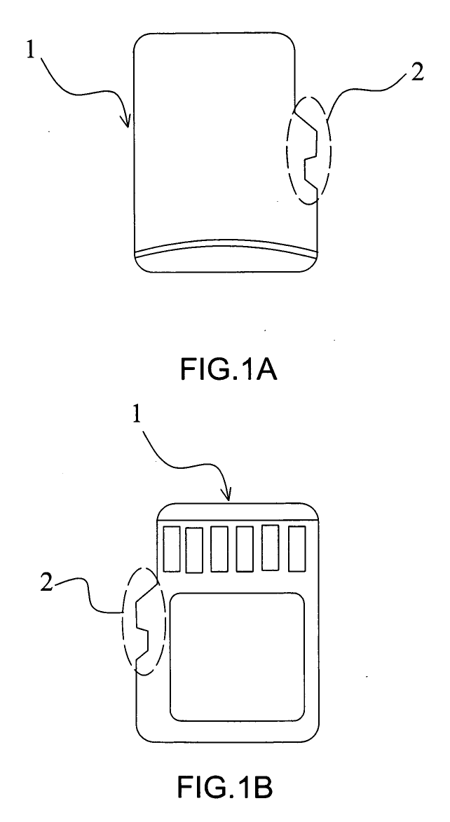

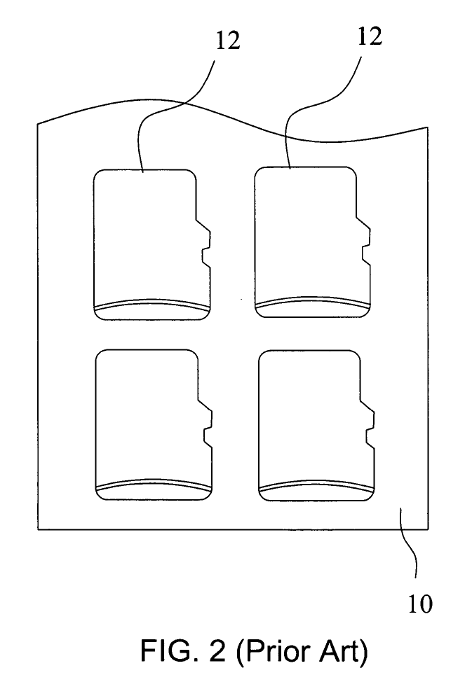

### DETAILED DESCRIPTION OF THE INVENTION

To explain a forming method of the Micro SD card with a preferred embodiment of the present invention;

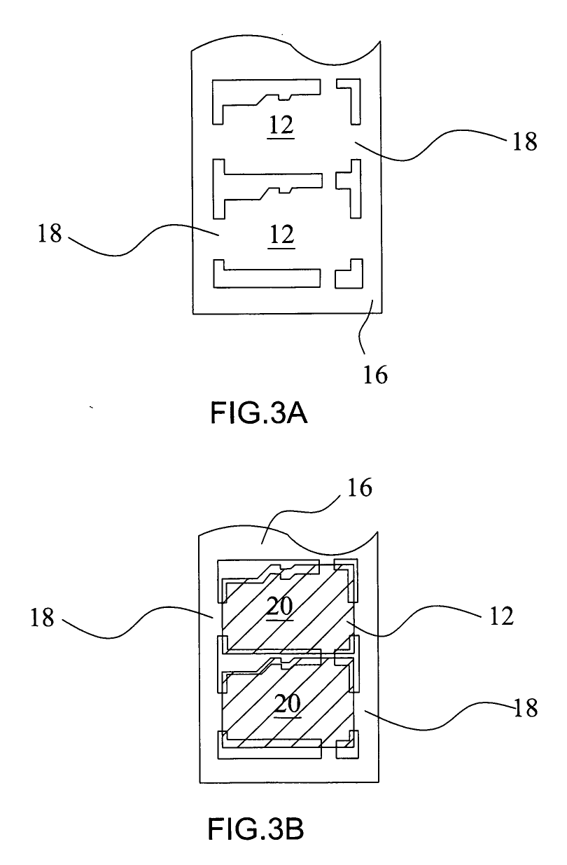

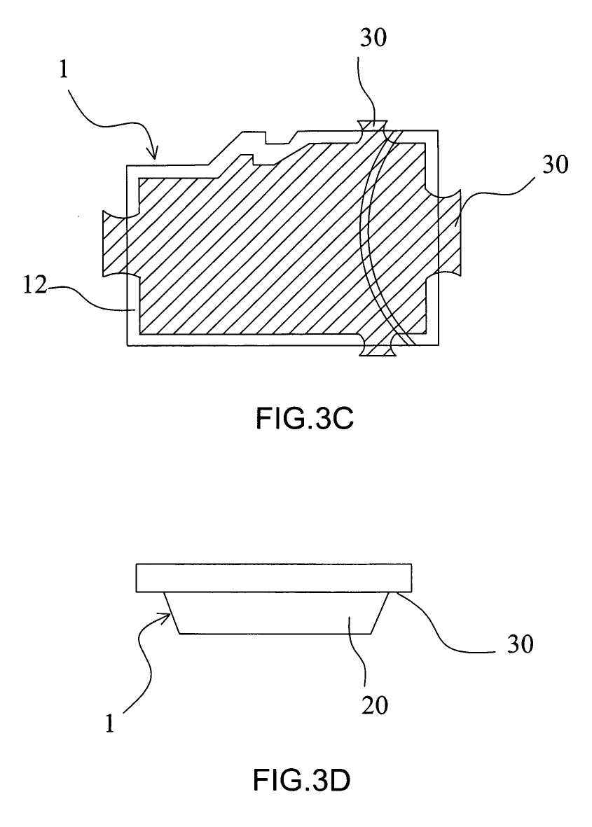

First of all, please refer to FIG. 3A, illustrating the substrate design in accordance with an embodiment of the present invention. In this embodiment, there are the plurality of Micro SD card module substrates 12 are arranged on the substrate 16 and connected every adjacent Micro SD card module substrate 12 and the substrate 16 with the plurality of connecting bars 18. Between the plurality of connecting bars 18 and the Micro SD module substrate 12 is the hollow portion of the substrate 16. Shown in FIG. 3B, illustrating the molding area of Micro SD card assembly before punch in accordance with an embodiment of the present invention. Placing the chip (not shown) on the proper location of the Micro SD card module substrate 12 and cover the Micro SD module substrate 12 by a molding compound 20, which made of epoxy. Wherein the geometric figure formed by the molding compound 20 is similar to the Micro SD card module substrate 12 but a little bit larger than the size of the Micro SD card module substrate 12. Besides, in order to avoid the molding compound squeeze out when molding, may pastes tapes on the surface of the cavity (not shown) and let the substrate 16, the Micro SD card module substrate 12 and the cavity (not shown) close together and the molding compound 20 will not squeeze out. Then, utilizing the punch device process the punching step, dismembering the plurality of connecting bars 18 to separate Micro SD card 1, the substrate 16 and the adjacent Micro SD card 1.

Please refer to FIG. 3C, illustrating the Micro SD card assembly, which after punch in accordance with an embodiment of the present invention. In order to avoid the molding compound 20 peeling or the Micro SD card 1 cracks, which because the punch location is too close to the Micro SD card 1 when punching, the distance of the punch location will distance a little bit from the Micro SD card 1. Therefore, the Micro SD card 1 after punching has the plurality of bumps 30, the side view of the bump 30 is shown in FIG. 3D. These bumps are the portion of the original connecting bar 18 of the substrate 16.

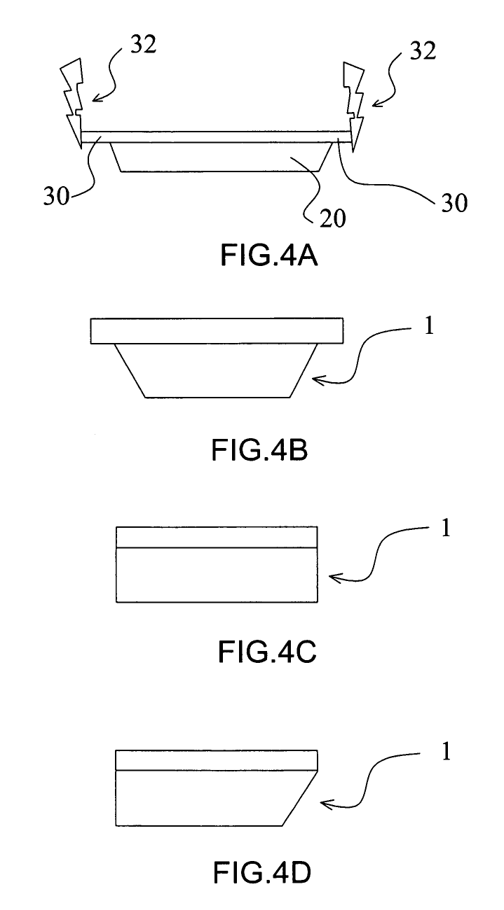

Next, FIG. 4A, FIG. 4B, FIG. 4C and FIG. 4D illustrating the smoothing steps in accordance with an embodiment of the present invention, it can use the saw-tooth tool 32 to polish the extra, unnecessary molding compound (such as the portion of the bump 30). In one embodiment, it may use several steps to grind the detail portion by different polish tools. For example, in the beginning of the smoothing steps, it may choose rough pellet or surface tools to grind, polish the plurality of bumps 30 promptly. Please refer to FIG. 4B, until the bump 30 almost disappear, now may choose smoother pellet or surface tools to smoothing the whole edge of the Micro SD card 1. Referring to FIG. 4C, start the chamfer steps to form the Micro SD card 1, as international standard size and shape, after the whole edge of the Micro SD card become smoothly. It is to be understood, the chamfer step can also separates to several steps to process. The size of the Micro SD card 1 after punch will become international standard size step by step according to the smoothing steps. By the way, the smoothing tool not limited on the saw-tooth tool, it may be suitable for using the dice (which made of diamond and used to dicing the wafer) to dicing the tiny bump 30 and the bump 30 which very close to the Micro SD card 1. Or it may choose the high rotate speed router (which used to route and to form the print circuit board) to remove the plurality of bumps 30 to smooth surface.

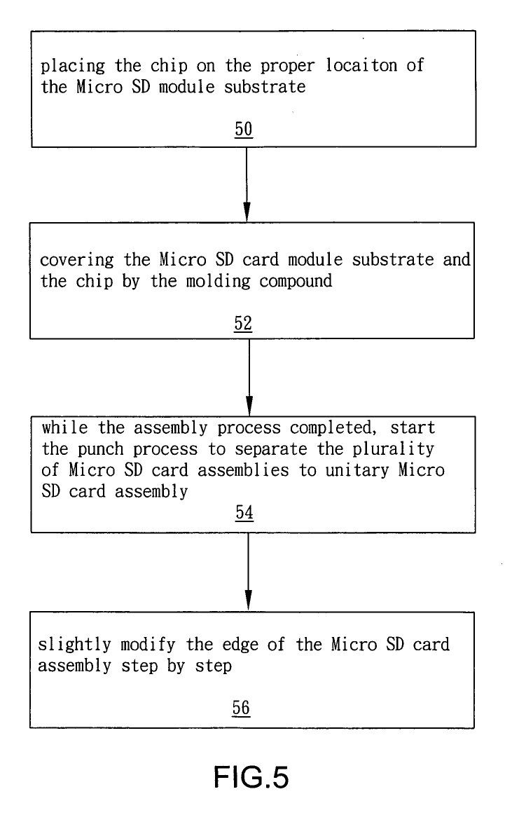

FIG. 5 is a flow chart illustrating the Micro SD card forming method in accordance with an embodiment of the present invention. Providing a substrate, which has the plurality of Micro SD card module substrates on it and placing the chip on the proper location of the Micro SD card module substrate (step 50). And then cover the Micro SD card module substrate and the chip by the molding compound (step 52). While the assembly process completed, start punch and separate the plurality of Micro SD card assemblies as the plurality of unitary Micro SD card assemblies (step 54) and then smoothing the edge of the Micro SD card assembly step by step (step 56), wherein the smoothing step includes grind, polish and chamfer.

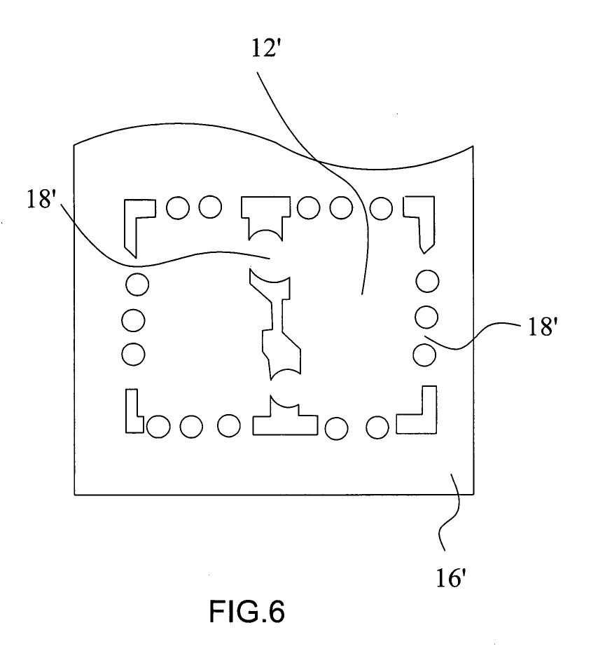

FIG.6 illustrating the shape of the connecting bars 18′, the distribution of the connecting bars 18′, and the mount of the connecting bars 18′ in accordance with different embodiments of the present invention. The plurality of connecting bars 18′ are used to connect the plurality of adjacent Micro SD card module substrates 12′ and not limited as shown in this embodiment of the present invention. The location, the shape, and the size of the connecting bars 18′ may be variable, just depends on the different arrangements of Micro SD card module substrate 12′ on the substrate 16′.

Accordingly, utilizing arrange the plurality of Micro SD card module substrates on the substrate in accordance with an embodiment of the present invention, wherein using the plurality of connecting bars connect the substrate and the adjacent Micro SD card module substrates. Then dismember the plurality of connecting bars to separate the plurality of individual Micro SD cards by punch method. Due to there exist a buffer space between the connecting bar and the Micro SD card assembly, it may avoid the molding compound peeling or the assembly cracks when punch location is too close to the assembly. When process molding, it is not necessary to cover the whole substrate, just need injecting the molding compound into the Micro SD card module substrate. As this result, the cost of the molding compound can be saved. Furthermore, the punch device is more inexpensive than the laser-cutting machine or the water jet machine, besides raise the production yield; it not only raise the productivity but also reduce the production cost.

Although the present invention has been explained in relation to its preferred embodiment, it is to be understood that other modifications and variation may be made without departing the spirit and scope of the invention as hereafter claimed.

What is claimed is:

1. A forming method of micro secure digital card, comprising:
providing a substrate having a plurality of micro secure digital card module substrates, wherein every said micro secure digital card module substrate is connected with said substrate and adjacent said micro secure digital card module substrates with a plurality of connecting bars;
covering said plurality of micro secure digital card module substrates by a molding material to form a plurality of micro secure digital card assemblies;
dismembering said plurality of connecting bars to separate said plurality of individual micro secure digital card assemblies; and
smoothing every said individual micro secure digital card assembly.

2. The forming method of micro secure digital card according to claim 1, wherein said molding material is made of epoxy.

3. The forming method of micro secure digital card according to claim 1, wherein said dismembering step uses a punch device to separate said plurality of connecting bars.

4. The forming method of micro secure digital card according to claim 1, wherein said smoothing process uses a saw-tooth tool to remove a portion of said plurality of connecting bars of every said micro secure digital card assembly.

5. The forming method of micro secure digital card according to claim 1, wherein said smoothing process may uses the dice to dice a portion of said plurality of connecting bars of every said micro secure digital card assembly.

6. The forming method of micro secure digital card according to claim 1, wherein said smoothing process may uses the high rotate speed router to route a portion of said plurality of connecting bars of every said micro secure digital card assembly.

7. The forming method of micro secure digital card according to claim 1, wherein the shape of said plurality of connecting bars is in polygon, bar, round shape, or multi-radian shape.

8. A forming method of micro secure digital card, comprising:
providing a substrate having a plurality of micro secure digital card module substrates thereon, wherein every said micro secure digital card module substrate is connected with said substrate and adjacent said micro secure digital card module substrates with a plurality of connecting bars;
placing a chip on each of said micro secure digital card module substrates;
covering said plurality of micro secure digital card module substrates and said chips by a molding material to form a plurality of micro secure digital card assemblies;
dismembering said plurality of connecting bars to separate said plurality of individual micro secure digital card assemblies;
grinding a portion of said plurality of connecting bars of said plurality of individual micro secure digital card assemblies; and
chamfering every said plurality of individual micro secure digital card assemblies.

9. The forming method of micro secure digital card according to claim 9, wherein said molding material is made of epoxy.

10. The forming method of micro secure digital card according to claim 9, wherein said dismembering step uses a punch device to separate said plurality of connecting bars.

11. The forming method of micro secure digital card according to claim 9, wherein the shape of said plurality of connecting bars is in polygon, bar, round shape, or multi-radian shape.
